(19) United States
(12) Patent Application Publication
(10) Pub. No.: US 2025/0125459 A1
(43) Pub. Date: Apr. 17, 2025

(54) Electrochemical Cell

(71) Applicant: Lina Energy Ltd., Lancaster (GB)

(72) Inventors: Andreas Karl Backstrom, Lancaster (GB); Richard James Dawson, Lancaster (GB); Kristopher Thomas Barr, Lancaster (GB)

(21) Appl. No.: 18/411,434

(22) PCT Filed: Jul. 11, 2022
(86) PCT No.: PCT/GB2022/051787

§ 371 Date: Jan. 12, 2024

(30) Foreign Application Priority Data
Jul. 15, 2021 (GB) 2110221.5

(51) Int. Cl. H01M 50/186; H01M 10/39; H01M 10/656; H01M 50/105; H01M 50/119; H01M 50/184; H01M 50/211; H01M 50/434

(52) U.S. Cl. CPC H01M 50/186; H01M 10/399; H01M 10/656; H01M 50/105; H01M 50/119; H01M 50/184; H01M 50/211; H01M 50/434

(57) ABSTRACT

An electrochemical cell (30, 30a, 50) comprises two electrode compartments (14, 15) defined in part by a first metal plate (31) and by a second metal plate (12), wherein the first metal plate (31) is dish-shaped and defines a peripheral rim (32), the second metal plate (12) is dish shaped and defines a rim (33) to mate with the peripheral rim of the first plate. and the cell comprises a sealing element (37) between the peripheral rims (32, 33). The cell also comprises a projecting peripheral sleeve (38) that is spaced from and outside the edge of the rim (33) of the second metal plate (12); and the cell comprises a compression sleeve (40; 52) held within the peripheral sleeve (38) and having a flat face to compress the sealing element (37), and a second face adjacent to the inner face of the peripheral sleeve (38). The compression sleeve (40; 52) is secured in position by the peripheral sleeve (38).

The present invention relates to an electrochemical cell, and to a battery assembly that comprises a multiplicity of such cells; such a cell and a battery assembly may operate at an elevated temperature.

A number of different types of electrochemical cell are known that require an elevated temperature to operate. These include cells in which an electrolyte must be at elevated temperature to provide adequate conductivity; and cells in which an electrode must be at elevated temperature for an electrode component to be liquid. One such type of cell is a molten sodium-metal halide rechargeable battery, such as the sodium/nickel chloride cell which may be referred to as a ZEBRA cell (see for example J. L. Sudworth, “The Sodium/Nickel Chloride (ZEBRA) Battery (J. Power Sources 100 (2001) 149-163). A sodium/nickel chloride cell incorporates a liquid sodium negative electrode separated from a positive electrode by a solid electrolyte which conducts sodium ions. The solid electrolyte may for example consist of beta alumina. The positive electrode includes nickel, nickel chloride and sodium tetrachloroaluminate which is liquid during use and acts as a secondary electrolyte to allow transport of sodium ions from the nickel chloride to the solid electrolyte. The positive electrode also incorporates aluminium powder. Partial replacement of the nickel with other transition metals such as iron can result in additional discharge voltage levels. The cell operates at a temperature which is typically below 350° C., but must be above the melting point of the sodium tetrachloroaluminate, which is 157° C., and the operating temperature is typically between 270° and 300° C. During discharge the normal reactions are as follows:

Cathode (positive electrode): NiCl₂+2Na⁺+2e⁻→Ni+2NaCl

Anode (negative electrode): Na→Na⁺+e⁻

the overall result being that anhydrous nickel chloride (in the cathode) reacts with metallic sodium (in the anode) to produce sodium chloride and nickel metal; and the cell voltage is 2.58 V at 300° C.

A modified type of a ZEBRA cell, that is to say a molten sodium-nickel chloride rechargeable cell, is described in WO 2019/073260. This uses an electrolyte element that comprises a perforated sheet of non-reactive metal, and a non-permeable layer of sodium-ion-conducting ceramic bonded to one face of the perforated sheet. In this electrolyte element the strength can therefore be provided by the metal sheet, and this enables the electrolyte thickness to be significantly reduced as compared to that required in a conventional ZEBRA cell. This results in a cell or a battery that can perform adequately at significantly lower temperatures, for example less than 200° C. Furthermore, a significantly thinner layer of ceramic also significantly reduces stresses induced by heating from ambient, so start-up times from ambient can be just a few minutes. These are both commercially advantageous benefits. The non-permeable layer is bonded to the perforated metal sheet, and this bonding may be by a porous ceramic sub-layer. Such a cell includes a metal case, which may have a peripheral flange.

An alternative form of molten sodium/nickel chloride cell is described in WO2022-123246 in which the electrolyte is again a planar sheet of ceramic that can conduct ions of the alkali metal, and a perforated planar sheet of an inert metal is immediately adjacent to the sheet of ceramic and in contact with the sheet of ceramic over substantially its entire area, to provide support to the sheet of ceramic. The ceramic sheet is formed separately from the perforated planar sheet, rather than being formed by deposition onto it.

In each of these cells the electrolyte separates the anode chamber from the cathode chamber, and there is a requirement for a seal to ensure the materials in the anode and cathode chambers do not come into contact with each other, or leak out of the cell; the seal also prevents air from coming into contact with the materials within the anode chamber and within the cathode chamber. Where there is a seal between an anode chamber casing and a cathode chamber casing, the seal must be electrically insulating and also able to withstand the operating temperature of the cell, which may be above 200° C.

According to the present invention there is provided an electrochemical cell comprising two electrode compartments, one being an anode compartment and the other being a cathode compartment, one electrode compartment being defined in part by a first metal plate and the other electrode compartment being defined in part by a second metal plate, wherein the first metal plate is dish-shaped and defines a peripheral rim, the second metal plate is dish shaped and defines a rim to mate with the peripheral rim of the first plate, and the cell comprises a sealing element between the peripheral rim of the first plate and the rim of the second plate; wherein the cell also comprises a projecting peripheral sleeve that is spaced from and outside the edge of the peripheral rim of the second metal plate; and the cell comprises a compression sleeve held within the peripheral sleeve, the compression sleeve having a flat face to compress the sealing element, and a second face adjacent to the inner face of the peripheral sleeve; wherein the compression sleeve is secured in position by the peripheral sleeve.

The cell may be a modified ZEBRA cell as described above, such that the anode compartment of the cell when charged contains an alkali metal, and the cathode compartment of the cell when charged contains a cathodic material that can react reversibly with ions of the alkali metal; wherein the anode compartment is separated from the cathode compartment by a planar sheet of a ceramic that can conduct ions of the alkali metal. So the ceramic sheet is the cell electrolyte.

The planar sheet of ceramic may for example be rectangular, square, or any other polygonal shape; it may have rounded corners; or it may be circular or elliptical. It determines the area of the cell through which ionic conduction occurs between the two electrode compartments.

The projecting peripheral sleeve may be integral with and defined by the first metal plate. Alternatively the projecting peripheral sleeve may be a separate component. The projecting peripheral sleeve may be of thicker material than the first metal plate. The compression sleeve is secured by the peripheral sleeve, for example by crimping or rolling over the edge of the peripheral sleeve, or by fixing the compression sleeve to the peripheral sleeve for example by welding, such as laser welding or spot welding. Alternative ways of fixing the compression sleeve to the peripheral sleeve would be by use of adhesive, or rivets, or screws.

The compression sleeve may be of metal, for example a sheet having an L-shaped cross-section. Alternatively the compression sleeve may be of an insulating material, and may fill substantially all the space between the peripheral sleeve and the outer surface of the second metal plate. Where the compression sleeve is of metal, the cell also comprises an electrical insulator between the flat face of the compression sleeve and the outer surface of the peripheral rim of the second plate. In either case the compression sleeve must be sufficiently rigid to maintain compression of the sealing element. If it is of metal it may be of thicker material than that of the first and second metal plates; if it is of L-shaped cross-section it may include struts or stiffening elements to hold the two parts of the L in their relative positions and so to prevent bending of the two parts relative to each other.

Where the cell has a ceramic sheet as its electrolyte, the anode compartment and/or the cathode compartment preferably also comprises a perforated planar sheet of an inert metal immediately adjacent to the sheet of ceramic and in contact with the sheet of ceramic over substantially its entire area, to provide support to the sheet of ceramic, the ceramic sheet either being formed by deposition as a layer onto the perforated metal sheet, or alternatively being formed separately from the perforated planar sheet. The ceramic electrolyte sheet must be non-permeable to gases or liquids, but must be a conductor of the ions that must pass between the anode and cathode compartments during operation.

The alkali metal may be lithium, sodium, potassium or rubidium; sodium is a suitable metal. The anode compartment may also comprise a carbon felt, preferably highly porous, to assist in the transfer of sodium metal away from or towards the sheet of ceramic, during charging and discharging of the cell. The carbon felt is highly porous, and preferably graphitic, and may for example have a density of about 60 kg/m³ or less. It may for example be a felt of areal density 100 g/m² and of thickness about 1.5 mm.

The metal of which the perforated sheet is formed is “inert” in the sense that it does not react chemically with components of the cell with which it is in contact during use; it may for example be a metal such as nickel, or aluminium-bearing ferritic steel (such as the type known as Fecralloy™, or a steel that forms an electronically-conductive and adherent scale, for example a CrMn oxide scale, when heated in air. The perforated sheet may be of thickness no more than 1.0 mm, or no more than 0.5 mm, for example 0.1 mm or 0.2 mm. The sheet is perforated so it has a very large number of through holes, and the perforations or holes may be of mean diameter less than 50 μm, for example 30 μm or less, or of mean diameter between 50 μm and 300 μm, and may for example be produced by a laser drilling process or by chemical etching. The through holes may have their centres spaced apart at between 100 μm and 500 μm, for example 150 μm.

The perforated sheet may have a margin around its periphery that is not perforated; this margin may make it easier to seal the periphery of the perforated plate to adjacent components of the cell. This margin may be of width no more than 15 mm, for example 10 mm or 5 mm or 3 mm.

The perforated sheet is preferably in the anode compartment, where it will help wick the molten sodium towards the surface of the ceramic sheet. It is in contact with the ceramic sheet over the area of the ceramic sheet through which sodium ion conduction occurs during use. The edge of the perforated sheet may be welded to the adjacent anode plate.

If the ceramic sheet electrolyte is formed separately, the perforated sheet would be held up against the ceramic sheet electrolyte either by the carbon felt or by being adhered to the electrolyte by a sintering of a porous layer between the metal and the electrolyte. The sintering of the porous layer may be carried out at a lower temperature than that used to form the ceramic electrolyte layer, for example at 1100° C., by including a sintering aid in the composition used to form the porous layer. The metal of the perforated sheet preferably has a coefficient of thermal expansion slightly greater than that of the ceramic electrolyte sheet, so that at the operating temperature of the cell the ceramic sheet is held under compression.

Alternatively the ceramic sheet is formed as a layer by deposition onto the perforated metal sheet. In this case there is preferably a porous liquid-permeable ceramic sub-layer between the perforated metal sheet and a non-permeable ion-conducting ceramic layer that is the electrolyte. The deposition may be carried out in two stages, using slurries of ceramic precursors, for example with larger particles in a slurry to form the porous and permeable sub-layer than in a slurry to form the ceramic electrolyte layer.

The metal plates that define in part the anode compartment and the cathode compartment are also of inert metal, in the sense that they do not react with the contents of the respective compartments during use. They may be the metals mentioned above as suitable for the perforated sheet. The metal plate that defines in part the anode compartment may be of steel, for example stainless steel; the metal plate that defines in part the cathode compartment may for example be of nickel, or of stainless steel coated with nickel on the inside surface.

Such a cell operates at an elevated temperature. A conventional sodium/nickel chloride cell, or ZEBRA cell, operates at 280° C. or 300° C. The operating temperature depends in part on the nature of the electrolyte and its ionic conductivity; a cell with a thin layer of ceramic as the electrolyte may have a lower operating temperature, for example in the range 175° C. to 225° C. In any event the sealing between the cell components must remain tight at the elevated temperature of operation. The sealing may utilise a high-temperature polymer such as a polyimide (e.g. Kapton™) or PTFE, or an inorganic material of an electrical insulator, such as mica or vermiculite. Such high-temperature polymers are preferably not used to seal the anode compartment, as they may interact with the molten sodium.

Since the first metal plate is dish-shaped with a peripheral rim, a cell formed in this way will define a projecting flange which is thinner than the region of the cell that contains the anode and cathode compartments. Where multiple such cells are stacked together to provide a higher electrical output, the temperature of the cells may be controlled by a heat transfer fluid, such as air, arranged to flow in the gaps between such flanges.

Hence multiple such cells may be assembled into at least one stack to form an electric battery assembly. Each cell as described above has a metal case whose opposite faces have opposite polarity, so that cells can be stacked directly in contact with each other, all with the same orientation, with all the cells of the stack being electrically in series. Where the cells operate at an elevated temperature, as described above, the assembly may also comprise at least one generally rectangular frame that defines a rectangular aperture to locate a stack of cells, such that the flanges of the cells in the stack are adjacent a wall of the frame.

The frame may be of metal. Alternatively the frame may be of a thermal insulation material, to inhibit heat loss from the cells to the environment, and its strength and durability must be unaffected when in thermal contact with the cells at their operating temperature, which may be up to 200° C., 300° C. or 400° C., depending on the type of cell. A uitable material may have a density less than 300 kg/m³ and a thermal conductivity less than 0.05 W/m·K. One such material is a resin-bonded sheet of rock wool fibres (made by melting rock and forming fibres from it), for example that available under the name Rockwool (trade mark), which may have a density of 100 or 140 kg/m³ and a thermal conductivity between 0.03 and 0.04 W/m·K. Another suitable material is a microporous fumed silica material like that sold by Vacutherm under the brand VACUPOR, and this provides even better thermal insulation, with a thermal conductivity that may be as little as 0.01 W/m·K.

The electric battery assembly may also include a pump to pass a heat transfer fluid through the rectangular aperture of each frame, so that the heat transfer fluid flows between the flanges of the cells adjacent to the wall of the frame. This heat transfer fluid may be air. In this case the pump may be a fan. During operation the cells will generate heat, so during operation the heat transfer fluid will be used to transfer heat away from the cells, to maintain the cells at an optimum operating temperature.

The invention will now be further and more particularly described, by way of example only, and with reference to the accompanying drawings in which:

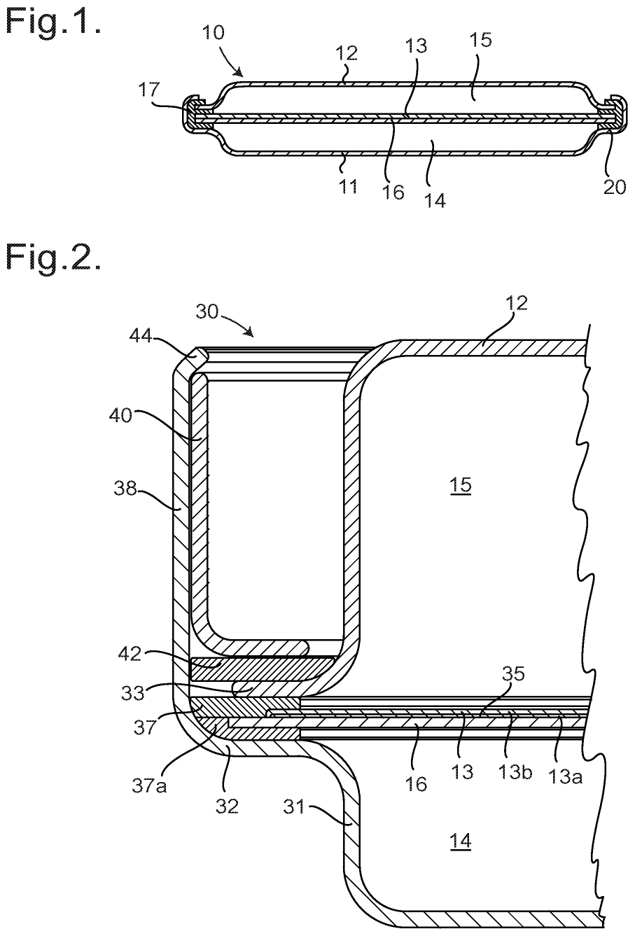

FIG. 1 shows a cross-sectional view through an electrical cell that is not a cell of the invention;

FIG. 2 shows a cross-sectional view of the sealing portion of a cell of the invention;

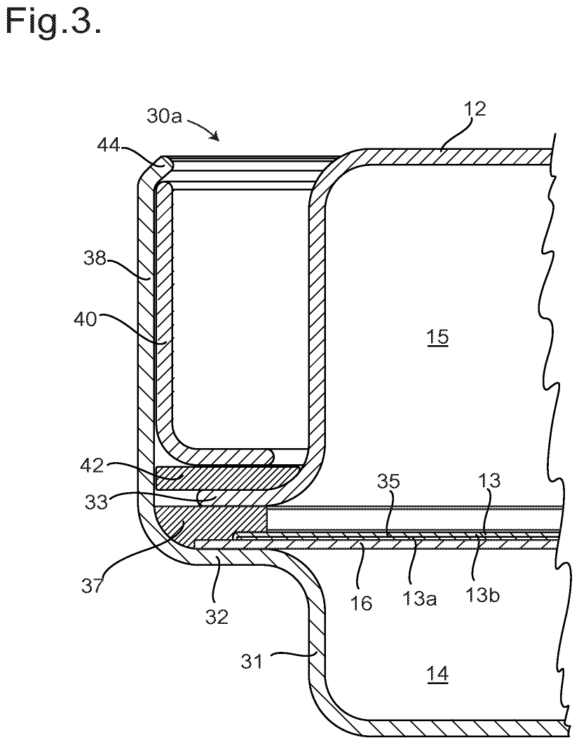

FIG. 3 shows a cross-sectional view of the sealing portion of a modification to the cell of FIG. 2;

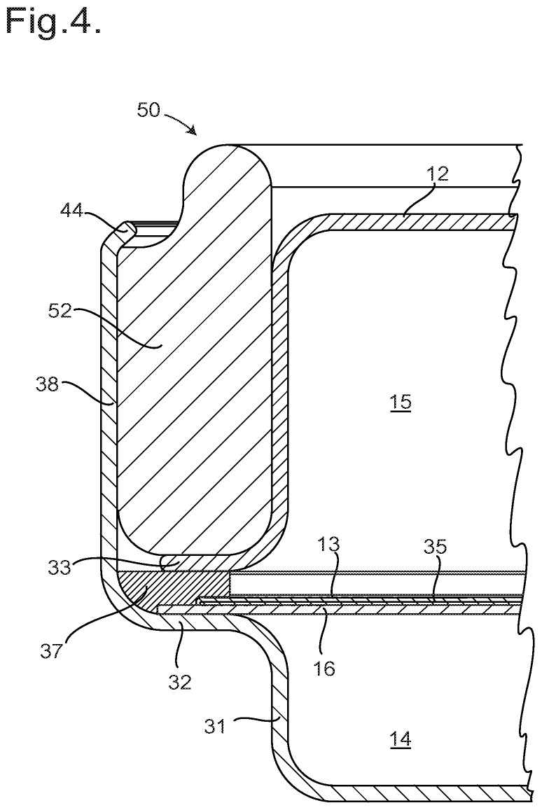

FIG. 4 shows a cross-sectional view of the sealing portion of an alternative cell of the invention;

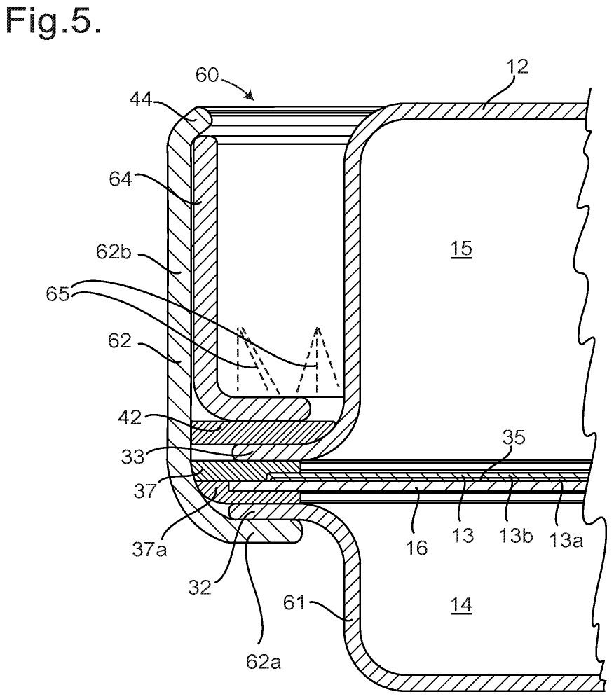

FIG. 5 shows a cross-sectional view of the sealing portion of an alternative modification to the cell of FIG. 2; and

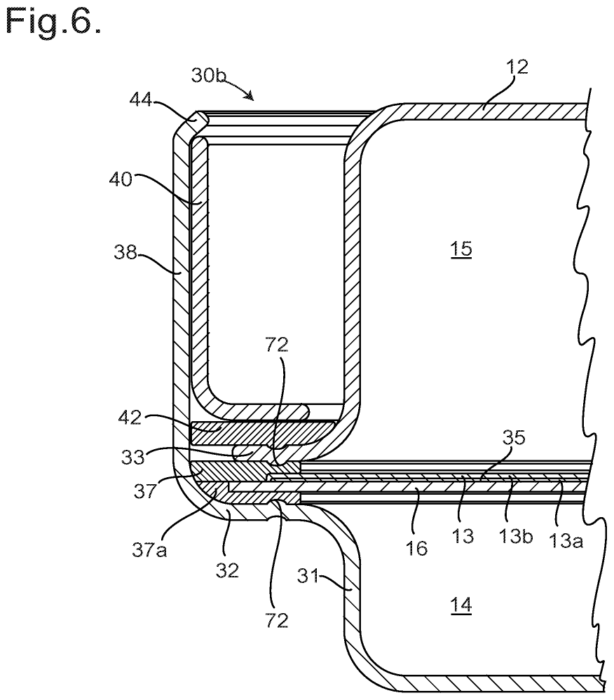

FIG. 6 shows a cross-sectional view of the sealing portion of another modification to the cell of FIG. 2.

Referring to FIG. 1, this shows a cell 10 which is as described in WO 2022/034346, and is not the subject of the present invention. The cell 10 operates at an elevated temperature, and comprises dish-shaped metal electrode plates 11 and 12 each defining a flat peripheral rim, between which is a sheet of electrolyte 13 deposited on a perforated metal sheet 16. The electrode plates 11 and 12, together with the electrolyte sheet 13, define an anode chamber 14 on one side of the electrolyte sheet 13 and a cathode chamber 15 on the other side of the electrolyte sheet 13, which contain chemicals that interact as a consequence of the passage of ions through the electrolyte sheet 13 to generate electricity. Around their periphery the rims of the electrode plates 11 and 12 are sealed to the sheet of electrolyte 13 and the perforated metal sheet 16 by a heat-resistant electrically-insulating sealant 17. The edges of the electrode plates 11 and 12 and of the electrolyte sheet 13 hence form a projecting edge flange 20 around the periphery of the cell 10, the flange 20 being thinner than the remainder of the cell 10. In this case the cell components are held together by crimping the edge of the electrode plate 11 around the edges of the electrolyte sheet 13 and the electrode plate 12, all of which are separated by the insulating sealant 17. In another modification there is no insulating sealant 17 between the edge of the electrolyte sheet 13 and the edge of one of the electrode plates 11 or 12, for example the plate 11 that forms the anode space 14; these edges may be hermetically welded together, and in this case the insulating sealant 17 only separates the edge of the plate 12 from both the plate 11 and the electrolyte sheet 13. The required operating temperature clearly depends upon the nature of the chemicals and the nature of the material of the electrolyte sheet 13. For example, operation may require a temperature in the range 100° C. to 300° C.

In particular the cell 10 may be a sodium/metal halide cell. One such type of cell is a sodium/nickel chloride cell. The electrode plates 11 and 12 may be of stainless steel, and of dished form to define the anode chamber 14 and the cathode chamber 15, with a flat peripheral rim. The perforated metal sheet 16 which supports the electrolyte sheet 13 may be of a metal such as nickel, or aluminium-bearing ferritic steel (such as the type known as Fecralloy™, or a steel that forms an electronically-conductive and adherent scale, for example a CrMn oxide scale, when heated in air. Most of the sheet 16 is perforated to produce a very large number of through holes. A margin around the periphery of the metal sheet 16, typically of width 5 mm, is not perforated. The perforated portion of the sheet 16 is covered by a porous and permeable ceramic sub-layer 13a which is itself covered by a non-permeable ceramic layer 13b (as shown in FIG. 2), the non-permeable ceramic layer 13b being of a sodium-ion-conducting ceramic. The non-permeable ceramic layer 13b may for example comprise beta alumina, but in addition it may contain a material that forms a glass during the sintering process. Thus although it is referred to as a ceramic layer, the term “ceramic” in this context includes combinations of ceramic and glass, as long as the layer is conductive to sodium ions during operation. The non-permeable ceramic layer 13b must not be permeable, that is to say it would be impermeable to gases, and consequently impermeable to liquids during operation. The non-permeable layer 13b also covers the edges of the sub-layer 13a (as shown in FIG. 2). The electrolyte sheet 13 thus consists of the combination of the permeable ceramic sub-layer 13a and the non-permeable ceramic layer 13b; these ceramic layers may be formed by deposition onto the metal sheet 16, so they are integral with each other.

The porous sub-layer 13a may be of the same sodium-ion-conducting ceramic as the non-permeable ceramic layer 13b. The porous and permeable ceramic sub-layer 13a may be of thickness between 10 μm and 100 μm, while the non-permeable layer 13b may be of thickness in the range 5 μm to 50 μm, for example 20 μm, 30 μm or 40 μm.

In its charged state the cell 10 would contain sodium metal in the anode space 14 and nickel chloride in the cathode space 15. However, the cell would typically be assembled in a completely discharged state, with nickel powder mixed with sodium chloride in the cathode space 15. In practice the cathode space 15 would be initially filled with a powder mixture containing nickel powder, sodium chloride, and sodium aluminium chloride (sodium tetrachloroaluminate, NaAlCl₄) and preferably also a small proportion other ingredients such as iron sulphide and iron chloride, and aluminium powder, and there may also be an expanded mesh nickel sheet embedded within the powder mixture to ensure good electrical contact. The anode space 14 may initially contain carbon felt, and the surfaces of the anode chamber 14 may be coated with carbon black.

For the cell 10 to operate, it must first be heated to a temperature above 157° C., such as 200° C., at which the sodium aluminium chloride is molten, and at such a temperature the non-permeable ceramic layer 13b of the electrolyte sheet 13 will conduct sodium ions sufficiently. The molten sodium aluminium chloride enables sodium ions to diffuse between the sodium chloride and the non-permeable ceramic layer. The cell can therefore be charged by applying a voltage from an external power supply between the two electrode plates 11 and 12, so sodium ions pass through the electrolyte sheet 13 into contact with the carbon felt in the anode space 14, where sodium metal is formed, while within the cathode space 15 the remaining chloride ions react with the nickel to form nickel chloride. The cell 10 is readily reversible, so it can be charged and discharged multiple times.

In a modification the non-permeable layer of the electrolyte sheet 13 may be made separately, and then mounted adjacent to the perforated metal sheet 16. In this case the electrolyte sheet 13 may be a sheet of sodium-ion-conducting ceramic such as NASICON or beta alumina, which may be referred to as beta alumina solid electrolyte (“BASE”). This sheet is not porous; but at temperatures above about 200° C. its ionic conductivity is high enough to allow sodium ions to pass through it at an adequate rate. This BASE form of electrolyte sheet 13 is of thickness no more than 2.0 mm, for example 1.0 mm, 0.6 mm or 0.5 mm. It may be made with a permeable sublayer on the face that is placed next to the perforated sheet 16; or it may be bonded to the perforated sheet 16 for example by sintering a slurry that forms a porous and permeable ceramic sub-layer.

Although the cell 10 described above has many advantages, it has been found that the crimping of the edge of the electrode plate 11 around the edges of the electrolyte sheet 13 and the electrode plate 12, so compressing the insulating sealant 17, does not readily provide sufficient sealing pressure for a satisfactory seal.

Referring to FIG. 2, there is shown an electric cell 30 of the present invention; it has many features in common with the cell 10, identical components being referred to by the same reference numbers. Only the sealing portion of the cell is shown, as the remainder of the cell is the same as in the cell 10.

The cell 30 comprises dish-shaped metal electrode plates 31 and 12, the plate 31 defining a peripheral rim or step 32 and the plate 12 defining a flat peripheral rim 33, between which is an electrolyte structure 35; the electrolyte structure 35 consists of a ceramic electrolyte sheet 13 in combination with a supporting perforated metal sheet 16 as described above; the porous sub-layer 13a and the non-permeable layer 13b are each shown. The electrode plates 31 and 12, together with the electrolyte sheet 13, define an anode chamber 14 on one side of the electrolyte sheet 13 and a cathode chamber 15 on the other side of the electrolyte sheet 13, which contain chemicals that interact as a consequence of the passage of ions through the electrolyte sheet 13 to generate electricity. Around their periphery the rim 33 of the electrode plate 12 and the step 32 of the electrode plate 31 are sealed to opposite faces of the electrolyte structure 35 by gaskets 37 and 37a of a heat-resistant electrically-insulating sealant.

The electrode plate 31 projects beyond the peripheral step 32 to define a projecting peripheral sleeve 38. The sleeve 38 projects to just less than the height of the dished part of the electrode plate 12. A compression sleeve 40 locates inside the projecting peripheral sleeve 38. The compression sleeve 40 is also of metal, and is L-shaped in cross-section, having one face up against the inner face of the peripheral sleeve 38, and another face parallel to the rim 33 of the plate 12 and separated from it by an electrically-insulating gasket 42.

During assembly, the compression sleeve 40 is inserted as shown and is pressed in with sufficient force to ensure the gaskets 37, 37a and 42 are compressed to provide a satisfactory seal; the compression sleeve 40 is then secured in this position by crimping or rolling over the edge of the peripheral sleeve 38, the rolled-in edge 44 fixing the compression sleeve in position and so maintaining the compression of the gaskets 37, 37a and 42. At the same time the peripheral sleeve 38 and the compression sleeve 40 may be spot welded together at a number of positions around the periphery of the cell 30, or may be laser welded together around the entire periphery.

Referring now to FIG. 3, this shows a cell 30a which is a modification to the cell 30 of FIG. 2; in this cell 30a no gasket 37a is provided between the step 32 and the electrolyte structure 35, but the gasket 37 is provided between the rim 33 of the electrode plate 12 and the opposite face of the electrolyte structure 35. In this case the periphery of the perforated metal sheet 16 may optionally be welded to the step 32.

Referring now to FIG. 4, this shows a cell 50 most of whose features are identical to those of the modified cell 30a as shown in FIG. 3. The cell 50 differs by not including the metal compression sleeve 40. Instead, the space between the projecting peripheral sleeve 38 and the outer face of the dished part of the electrode plate 12 is filled by a compression sleeve 52 in the form of a block of non-metallic, electrically-insulating and heat-resistant and substantially rigid material. The compression sleeve 52 is inserted with enough force to ensure the gasket 37 is compressed to ensure a satisfactory seal; the compression sleeve 52 is then secured in this position by crimping or rolling over the edge of the peripheral sleeve 38, the rolled-in edge 44 fixing the compression sleeve 52 in position and so maintaining the compression of the gasket 37.

Referring now to FIG. 5 there is shown a cell 60 which is a modification to the cell 30 of FIG. 2; most of the features are the same and are referred to by the same reference numerals. This cell 60 comprises dish-shaped metal electrode plates 61 and 12; the plate 61 defines a peripheral rim 32, and does not project further. A ring 62 of L-shaped cross-section has one part 62a that abuts the underside of the peripheral rim 32, and another part 62b that forms a peripheral sleeve. A compression sleeve 64 locates inside the projecting peripheral sleeve 62b. The compression sleeve 64 is also of metal, and is L-shaped in cross-section, having one face up against the inner face of the peripheral sleeve 62b, and another face parallel to the rim 33 of the plate 12 and separated from it by the electrically-insulating gasket 42.

The cell 60 is assembled as described above, the compression sleeve 64 being inserted as shown and pressed in with sufficient force to ensure the gaskets 37, 37a and 42 provide a satisfactory seal; the compression sleeve 64 is then secured in this position by crimping or rolling over the edge of the peripheral sleeve 62b, the rolled-in edge 44 fixing the compression sleeve 64 in position and so maintaining the compression of the gaskets 37, 37a and 42. At the same time the peripheral sleeve 62b and the compression sleeve 64 may be spot welded together at a number of positions around the periphery of the cell 60, or may be laser welded together around the entire periphery.

The cell 60 differs from the cell 30 in that the peripheral sleeve 62b is defined by a component which is separate from the electrode plate 61. Both the L-shaped ring 62 and the L-shaped compression sleeve 64 are of thicker metal than the electrode plates 12 and 61 and so significantly stiffer. By way of example the electrode plates 12 and 61 may respectively be of 0.2 mm thick nickel and 0.2 mm thick stainless steel, and the L-shaped ring 62 and the L-shaped compression sleeve 64 of stainless steel about twice as thick, for example 0.4 or 0.5 mm thick.

In a modification, prior to assembly of the cell 60, the part 62a of the ring 62 may be fixed to the underside of the peripheral rim 32, for example by laser welding. This may simplify the subsequent assembly process.

In a further option, the compression sleeve 40 or 64 may be provided with stiffening indentations to further inhibit bending of the two parts of the L, for example the indentations 65 indicated by broken lines in FIG. 5.

Referring now to FIG. 6 there is shown a cell 30b which is an alternative modification to the cell 30 of FIG. 2; most of the features are the same and are referred to by the same reference numerals. In the cell 70 the peripheral rims 32 and 33 define a narrow ridge 72, the two ridges 72 being directly opposite each other. These ridges 72 act as a bite feature, maximising the sealing pressure in the region between the opposed ridges 72. This arrangement applies the pressure specifically where it is required; this means that a satisfactory seal can be obtained with a reduced compressive force, while applying the pressure to the gaskets 37 and 37a where it is needed.

Thus as shown in FIG. 6 a symmetric bite feature (ridge 72) may be provided on each side of the electrolyte structure 35 on the metal electrode plates 12 and 31. As an alternative, such a ridge or bite feature may instead be provided on the electrolyte structure 35, for example with a glass bead (not shown) running around parallel to the edge of the electrolyte structure 35. As another alternative a bite feature or rigid strip may be embedded in the gaskets 37 and 37a, directly opposite each other. In each case these bite features allow the pressure to be maximised in a local area to give the sealing pressure required whilst reducing the overall load and so reducing any bending in the metal elements.

It will be appreciated that in a cell 30a (as shown in FIG. 3) in which the periphery of the electrolyte structure 35 is welded to the step 32 of the electrode plate 31, only one such bite feature is required to ensure the gasket 37 seals effectively. So for example a single ridge 72, as shown in FIG. 6, may be provided in the peripheral rim 33, and/or such a ridge may be provided in the portion of the compression sleeve 40 that is above the rim 33.

A number of different ways have been described above for improving the sealing of a cell, in particular using a peripheral sleeve and a compression sleeve that are of thicker steel sheet than the electrode plates (see cell 60 of FIG. 5); providing an L-shaped compression sleeve with stiffening indentations or struts (see features 65 in FIG. 5); providing opposed ridges to localise the sealing pressure (see ridges 72 in FIG. 6); or providing other ways to localise the sealing pressure (such as a glass bead on the electrode structure 35 as described above). It will be appreciated that these may be applied in combinations other than those specifically described above. For example stiffening indentations 65 are shown only in the context of a thicker-walled compression sleeve 64; but they may equally be applied in the context of a compression sleeve 40 that is of the same thickness as the electrode plates 12 and 31. As another example the bite feature of the opposed ridges 72 is shown only in the context of a compression sleeve 40 of the same thickness as the electrode plates 12 and 31; but such bite features would be equally applicable in the cell 60 where both the projecting sleeve 62 and the compression sleeve 64 are thicker-walled.

As regards their chemical compositions, cells 30, 30a, 30b, 50 and 60 of the invention may be the same as that of the cell 10. In their charged state the cells 30, 30a, 30b, 50 and 60 would contain sodium metal in the anode space 14 and nickel chloride in the cathode space 15. However, the cells 30, 30a, 30b, 50 and 60 would typically be assembled in a completely discharged state, as described above in relation to the cell 10, with nickel powder mixed with sodium chloride in the cathode space 15. In practice the cathode space 15 would be initially filled with a powder mixture containing nickel powder, sodium chloride, and sodium aluminium chloride (sodium tetrachloroaluminate, NaAlCl₄) and preferably also a small proportion other ingredients such as iron sulphide and iron chloride, and aluminium powder, and there may also be an expanded mesh nickel sheet embedded within the powder mixture to ensure good electrical contact. The anode space 14 may initially contain carbon felt, and the surfaces of the anode chamber 14 may be coated with carbon black.

For the cells 30, 30a, 30b, 50 and 60 to operate, they must first be heated to a temperature above 157° C., such as 200° C., at which the sodium aluminium chloride is molten, and at such a temperature the non-permeable ceramic layer 13b of the electrolyte sheet 13 will conduct sodium ions sufficiently, as explained above in relation to the cell 10. The molten sodium aluminium chloride enables sodium ions to diffuse between the sodium chloride and the non-permeable ceramic layer. The cell can therefore be charged by applying a voltage from an external power supply between the two electrode plates 31 or 61, and 12, so sodium ions pass through the electrolyte sheet 13 into contact with the carbon felt in the anode space 14, where sodium metal is formed, while within the cathode space 15 the remaining chloride ions react with the nickel to form nickel chloride. The cells 30, 30a, 30b, 50 and 60 are readily reversible, so they can be charged and discharged multiple times.

1. An electrochemical cell comprising two electrode compartments, one being an anode compartment and the other being a cathode compartment, the anode compartment of the cell when charged containing an alkali metal, and the cathode compartment of the cell when charged containing a cathodic material that can react reversibly with ions of the alkali metal, one electrode compartment being defined in part by a first metal plate and the other electrode compartment being defined by a second metal plate, and the anode compartment being separated from the cathode compartment by an electrolyte structure comprising a planar non-permeable sheet of a ceramic that can conduct ions of the alkali metal, wherein the first metal plate is dish-shaped and defines a peripheral rim, the second metal plate is dish shaped and defines a flat rim to mate with the peripheral rim of the first plate, and the cell comprises a sealing element between the peripheral rim of the first plate and the flat rim of the second plate to seal to the periphery of the electrolyte structure; wherein the cell also comprises a projecting peripheral sleeve that is spaced from and outside the edge of the peripheral rim of the second metal plate; and the cell comprises a compression sleeve held within the peripheral sleeve, the compression sleeve having a flat face parallel to the flat rim of the second metal plate to compress the sealing element, and a second face adjacent to the inner face of the peripheral sleeve; wherein the compression sleeve is secured in position by the peripheral sleeve.

2. A cell as claimed in claim 1 wherein the compression sleeve is secured by the peripheral sleeve by crimping or rolling over the edge of the peripheral sleeve.

3. A cell as claimed in claim 1 wherein the compression sleeve is secured by the peripheral sleeve, by fixing the compression sleeve to the peripheral sleeve.

4. A cell as claimed in claim 1 wherein the projecting peripheral sleeve is integral with and defined by the first metal plate.

5. A cell as claimed in claim 1 wherein the projecting peripheral sleeve is a separate component of generally L-shaped cross-section.

6. A cell as claimed in claim 1 wherein the projecting peripheral sleeve is of thicker material than the first metal plate.

7. A cell as claimed in claim 1 wherein the compression sleeve is of metal, and the cell also comprises an electrical insulator between the flat face of the compression sleeve and the outer surface of the peripheral flat rim of the second metal plate.

8. A cell as claimed in claim 7 wherein the compression sleeve is a sheet having an L-shaped cross-section.

9. A cell as claimed in claim 8 wherein the compression sleeve is of thicker material than the first metal plate.

10. A cell as claimed in claim 8 wherein the compression sleeve comprises struts or stiffening elements to hold the two parts of the L in their relative positions and so to prevent bending of the two parts relative to each other.

11. A cell as claimed in claim 1 wherein the compression sleeve is of an electrically-insulating material.

12. A cell as claimed in claim 11 wherein the compression sleeve fills substantially all the space between the peripheral sleeve and the outer surface of the second metal plate.

13. (canceled)

14. A battery assembly comprising multiple cells as claimed in claim 1 arranged as a stack, the periphery of each cell defining a projecting flange which is thinner than the region of the cell that contains the anode and cathode compartments, wherein a heat transfer fluid is arranged to flow in the gaps defined between such flanges.

15. A battery assembly as claimed in claim 14 wherein the stack of cells is arranged within a frame that defines an aperture to locate the stack of cells, such that the flanges of the cells in the stack are adjacent a wall of the frame.

16. A cell as claimed in claim 1 also comprising a perforated planar sheet of an inert metal immediately adjacent to the sheet of ceramic and in contact with the sheet of ceramic over substantially its entire area, to provide support to the sheet of ceramic, the ceramic sheet either being formed by deposition as a layer onto the perforated metal sheet, or alternatively being formed separately from the perforated planar sheet.

17. A cell as claimed in claim 1 also incorporating bite features to apply a localised sealing pressure to each sealing element.
